(19) United States
(12) Patent Application Publication
(10) Pub. No.: US 2005/0198755 A1
(43) Pub. Date: Sep. 15, 2005

(54) Shower enclosure and bathtub cleaning system

(76) Inventors: Thomas A. Panasci, Forest Hills, NY (US); Joseph Clemente, New York, NY (US)

Correspondence Address: Carter, DeLuca, Farrell & Schmidt, LLP, Suite 225, 445 Broad Hollow Road, Melville, NY, 11747, US

(21) Appl. No.: 11/072,165

(22) Filed: Mar. 4, 2005

Related U.S. Application Data
(60) Provisional application No. 60/551,234, filed on Mar. 9, 2004.

(51) Int. Cl. A46B 13/06

(52) U.S. Cl. 15/29

(57) ABSTRACT

A cleaning system for cleaning surfaces of a bath, shower enclosure, bath tub and the like is provided. The cleaning system includes a universal adapter configured and dimensioned for connection to a free end of a showerhead pipe of the bath; a tube having a first fitting provided at a first end thereof for fluid connection with the universal adapter, and a fitting provided at a second end thereof for fluid connection with a cleaning attachment; and a cleaning attachment attachable to the fitting at the second end of the tube. The cleaning attachment includes a handle portion including a first end configured for fluid connection with the second fitting of the tube; a head portion operatively supported on a second end of the handle portion; and at least one scouring element operatively associated with the head portion of the cleaning attachment.

### CROSS REFERENCE TO RELATED APPLICATION

The present application claims the benefit of priority to U.S. Provisional Application Ser. No. 60/551,234 filed on Mar. 9, 2004 entitled “SHOWER AND TUB CLEANER”, the entire contents of which being hereby incorporated by reference herein.

### BACKGROUND

1. Technical Field

The present disclosure relates to cleaning systems and methods, and more particularly, to systems and methods for cleaning and/or washing shower enclosures, bathtubs, and the like.

2. Background of Related Art

A dwelling (i.e., a home, an apartment, a hotel room, etc.) has many areas that must be cleaned periodically. For purposes of overall health and sanitation, surfaces in bathroom areas often require special cleaning efforts.

Clean bathroom surfaces are essential for many reasons. The moist wet surfaces in bathrooms provide a haven for bacteria and viruses and must be kept under control to prevent disease. If the surfaces in the bathroom are not kept sanitary or impeccably clean, a bathroom user can be exposed to such ailments as foot fungus, the common cold, or other more serious illnesses.

Conventional methods of cleaning surfaces of a bathroom typically consist of filling a bucket with detergent and water and manually scrubbing the surfaces with a sponge or brush. Such a method has many inherent problems. For example, this method involves repeatedly rinsing the brush and having to fill and dump the bucket numerous times to discard dirty water. The soap or detergent may also cause skin irritations or allergic reactions to any exposed skin. To overcome this drawback, the wearing of rubber gloves has been adopted. However, rubber gloves are known to be very uncomfortable because they promote excess sweating of the hands.

Another problem with manual cleaning is that the person cleaning must manipulate their body in many ways to reach all of the surfaces. This includes kneeling on hard surfaces which can cause knee and back problems. Reaching higher surfaces involves reaching over ones head. This latter movement can easily cause a person to lose their footing on slick surfaces, resulting in injury.

Various instruments and devices have been developed and employed to facilitate the cleaning of the surfaces of a bathroom, such as, for example, powered brushes and the like. In certain instances, the cleaning instruments and/or devices are fluidly attached to an existing fixture (e.g., shower head, bathtub faucet, etc.) of the bathtub or shower enclosure, or the fixture is removed from the water supply pipes and the cleaning instruments and/or devices are directly fluidly connected to a free end of the water supply pipes.

A continuing need exists for a system which facilitates the cleaning of surfaces of a bathroom including a shower enclosure, a bathtub and the like.

A need further exists for a system which facilitates the cleaning of surfaces of a bathroom including an adapter for enabling selective fluid connection of a bath fixture (e.g., a shower head) and a cleaning instrument or device to a free end of a water supply pipe.

### SUMMARY

The present disclosure relates to systems and methods for cleaning and/or washing shower enclosures, bathtubs, and the like.

According to one aspect of the present disclosure, a cleaning system for cleaning surfaces of a bath, shower enclosure, bath tub and the like is provided. The cleaning system includes a universal adapter configured and dimensioned for connection to a free end of a showerhead pipe of the bath; and a showerhead adapter configured and dimensioned for connection to a fitting of a shower head. The universal adapter and the showerhead adapter are configured for selective fluid-tight connection with one another. The cleaning system further includes a tube having a first fitting provided at a first end thereof for fluid connection with the universal adapter, and a fitting provided at a second end thereof for fluid connection with a cleaning attachment. The cleaning system also includes a cleaning attachment having a handle portion including a first end configured for fluid connection with the second fitting of the tube; a head portion operatively supported on a second end of the handle portion; and at least one scouring element operatively associated with the head portion of the cleaning attachment. In use, the showerhead is replaced by the tube and cleaning attachment for cleaning of the surfaces of the bath.

Desirably, the universal adapter includes a quick release coupling for engaging each of the showerhead adapter and the first fitting of the tube.

In an embodiment, the cleaning attachment may include a plurality of scouring elements extending from a first surface of the head portion. It is envisioned that the cleaning attachment may include a squeegee extending from a surface of the head portion which is opposite the scouring elements. Desirably, the head portion of the cleaning attachment may be pivotable with respect to the handle portion.

In an embodiment, the head portion of the cleaning attachment may include at least one aperture formed therein for discharge of fluid therefrom. The cleaning attachment may include a control switch for opening and closing the apertures formed in the head portion thereof.

In another embodiment, the scouring elements of the cleaning attachment may be capable of oscillating in a transverse direction and/or a longitudinal direction. It is envisioned that the scouring elements of the cleaning attachment may be capable of rotating. It is envisioned that the cleaning attachment may be configured and adapted to cause the scouring elements to rotate, oscillate in a transverse direction, and/or oscillate in a longitudinal direction.

The handle portion of the cleaning attachment may be elongated. In an embodiment, the handle portion of the cleaning attachment has a length of from about 6 inches to about 24 inches. In another embodiment, the handle portion of the cleaning attachment has a length of from about 24 inches to about 60 inches.

According to another aspect of the present disclosure, a cleaning system for cleaning surfaces of a bath, shower enclosure, bath tub and the like is provided. The cleaning system includes a universal adapter configured and dimensioned for connection to a free end of a showerhead pipe of the bath; a tube having a first fitting provided at a first end thereof for fluid connection with the universal adapter, and a fitting provided at a second end thereof for fluid connection with a cleaning attachment; and a cleaning attachment attachable to the fitting at the second end of the tube. The cleaning attachment includes a handle portion including a first end configured for fluid connection with the second fitting of the tube; a head portion operatively supported on a second end of the handle portion; and at least one scouring element operatively associated with the head portion of the cleaning attachment.

The universal adapter may include a quick release coupling for engaging the first fitting of the tube.

The cleaning attachment may include a plurality of scouring elements extending from a first surface of the head portion. The cleaning attachment may further include a squeegee extending from a surface of the head portion which is opposite the scouring elements.

The head portion of the cleaning attachment is desirably pivotable with respect to the handle portion. It is envisioned that the head portion of the cleaning attachment includes at least one aperture formed therein for discharging fluid therefrom. Desirably, the cleaning attachment includes a control switch for opening and closing the apertures formed in the head portion thereof.

It is envisioned that the cleaning attachment is configured and adapted to cause the scouring elements to rotate, oscillate in a transverse direction, and/or oscillate in a longitudinal direction.

The cleaning system may further include a showerhead adapter configured and dimensioned for connection to a fitting of a shower head. The universal adapter and the showerhead adapter are configured for selective fluid-tight connection with one another. Accordingly, in use, the showerhead is replaced by the tube and cleaning attachment when cleaning the surfaces of the bath.

For a better understanding of the present disclosure and to show how it may be carried into effect, reference will now be made, bay way of example, to the accompanying drawings.

### DETALIED DESCRIPTION OF THE DRAWINGS

FIG. 1 is a perspective view, with parts separated, of a cleaning system in accordance with an embodiment of the present disclosure;

FIG. 2 is a further perspective view, with parts separated, of the cleaning system of FIG. 1;

FIG. 3 is a perspective view of another embodiment of the cleaning system of the present disclosure;

FIG. 4 is a perspective view of a cleaning tool of the cleaning systems of FIGS. 1-3; and

FIG. 5 is a perspective view of another cleaning tool of the cleaning systems of FIGS. 1-4.

### DETAILED DESCRIPTION OF THE EMBODIMENTS

With reference to the drawings, new and improved systems and methods for cleaning and/or washing shower enclosure, bathtubs and the like, embodying the principles and concepts of the present disclosure will be described.

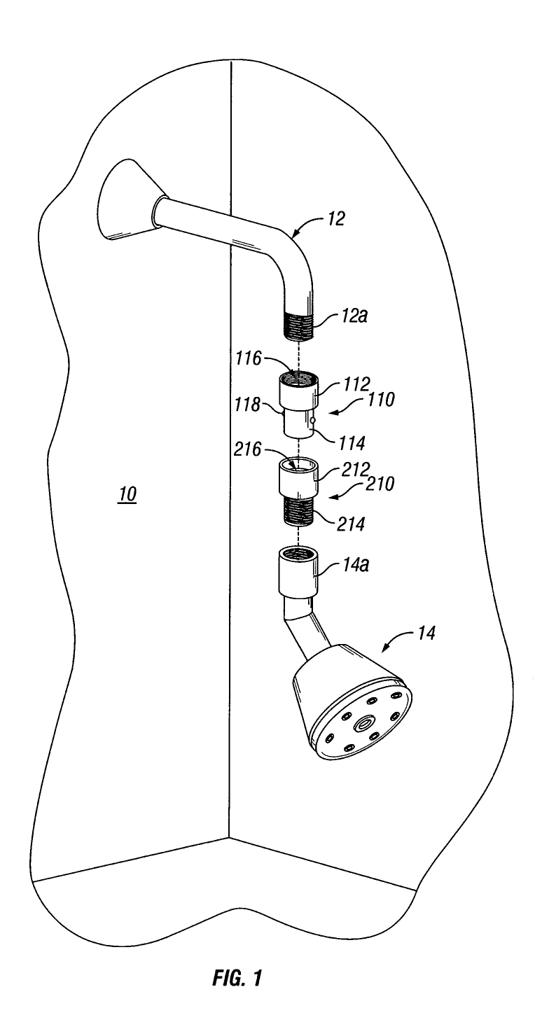

With reference to FIG. 1, an exemplary embodiment of a system for cleaning a shower enclosure, bathtub and the like, in accordance with an embodiment of the present disclosure, is generally designated as 100. Cleaning system 100 is intended for fluid connection to a free end of a shower head pipe 12 projecting from a shower wall 10 or other shower structure or the like. Shower head pipe 12 delivers a supply of water to a shower head or cleaning system 100, as will be described in greater detail below. As is typical, a distal end 12a of shower head pipe 12 is threaded for connection with complementary threads provided on a showerhead 14 or the like.

Cleaning system 100 includes a universal adapter 110, at least one cleaning attachment 120, and optionally an elongate hose or tube 130.

Universal adaptor 110 of cleaning system 100 includes a first end 112 configured and dimensioned to connect to distal end 12a of showerhead pipe 12, and a second end 114 configured and dimensioned to selectively connect with one of a plurality of components (e.g., showerhead 14, cleaning attachment 120, etc.). Universal adaptor 110 defines a lumen 116 enabling passage of fluid (e.g., water) and the like therethrough. Desirably, it is envisioned and within the scope of the present disclosure, for second end 114 of universal adapter 110 to include a quick release fluid coupling 118 for enabling quick and easy connecting and disconnecting of various components thereto. It is also envisioned that second end 114 may be configured and dimensioned for snap-fit, threaded, pressure, friction-fit and/or any other type of coupling known by one having ordinary skill in the art.

Cleaning system 100 further includes a showerhead adapter 210 configured and adapted to fluidly interconnect showerhead 14 to universal adapter 110. Showerhead adapter 210 includes a fist end 212 configured and dimensioned to selectively connect to second end 114 of universal adapter 110, and a second end 214 configured and adapted to selectively connect to a fitting 14a of showerhead 14. Showerhead adapter 210 defines a lumen 216 enabling passage of fluid (e.g., water) and the like therethrough. Desirably, it is envisioned and within the scope of the present disclosure, for first end 212 of showerhead adapter 210 to be configured and adapted to operatively engage quick release fluid coupling 118 of universal adapter 110.

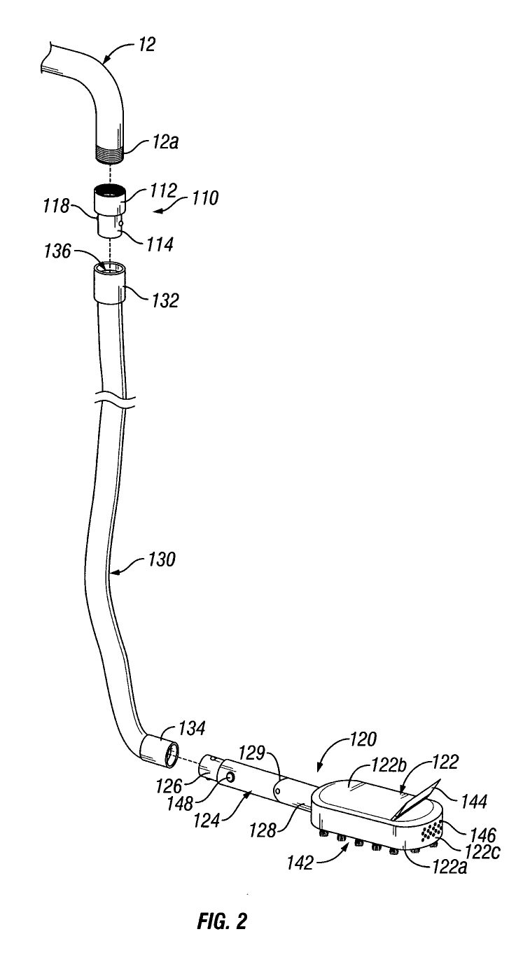

As seen in FIG. 2, tube 130 includes a first end having a first fitting 132 configured and dimensioned to connect with second end 114 of universal adaptor 110. Tube 130 includes a second end having a second fitting 134 configured and dimensioned to selectively connect with cleaning tool 120. Tube 130 defines a lumen 136 enabling passage of fluid (e.g., water) and the like therethrough. Desirably, it is envisioned and within the scope of the present disclosure, for first fitting 132 of tube 130 to include a quick release fluid coupling configured and adapted to cooperate with quick release fluid coupling 118 of adapter 110 to enable quick release and coupling thereof. It is further envisioned and within the scope of the present disclosure, for second fitting 134 of tube 130 to include a quick release fluid coupling (not shown) for enabling quick and easy connecting and disconnecting of various cleaning tools and the like thereto.

Desirably, depending on the size of the shower enclosure, bath tub or the like, an appropriate length tube 130 is connected to second end 114 of universal adaptor 110 which enables the user to reach all of the surfaces or a selected number of surfaces of the shower enclosure with cleaning tool 120.

It is envisioned that a fluid-tight seal is provided between second end 114 of universal adapter 110 and first end 132 of hose 130. For example, an O-ring or the like (not shown) may be used to create the fluid-tight seal between second end 114 of universal adapter 110 and first end 132 of hose 130.

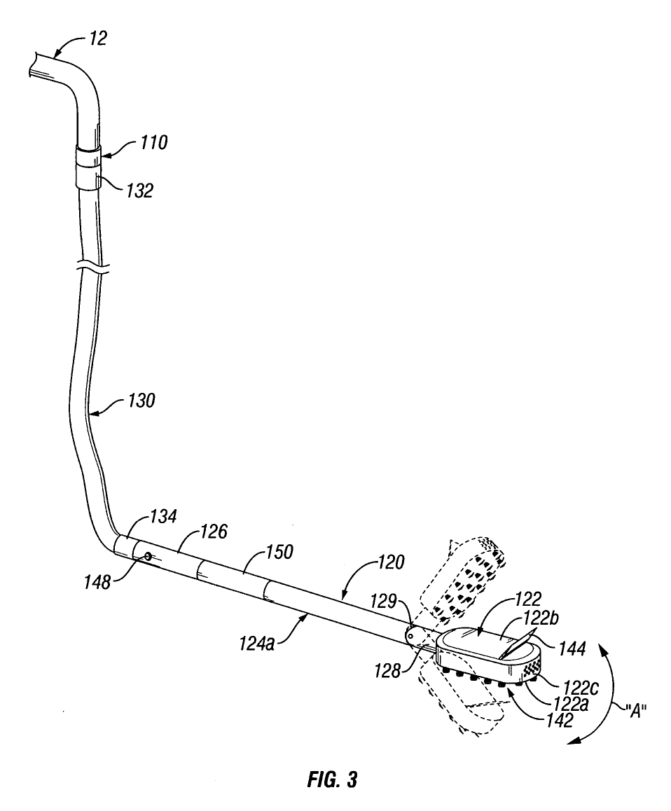

Cleaning attachment or tool 120 of cleaning system 100 further includes a working head portion 122 configured and adapted to affect cleaning and/or scrubbing of a desired surface. Cleaning attachment 120 includes a handle portion 124 having a first end 126 configured and dimensioned to connect with second end 134 of tube 130, and a second end 128 configured and dimensioned to support working head portion 122. Cleaning attachment 120 may have a handle portion 124 having a length of from about 6 inches to about 24 inches, as seen in FIG. 2, or cleaning attachment 120 may have a handle portion 124a having a length from about 24 inches to about 60 inches, as seen in FIG. 3. In accordance with the present disclosure, depending on the size and shape of the shower enclosure or bath tub that is to be cleaned, a cleaning attachment 120 having either a shorter handle portion 124 or a longer handle portion 124a will be attached to tube 130 in order to facilitate the cleaning thereof.

Desirably, cleaning attachment 120 includes a tilt action hinge 129 or the like between handle portion 124, 124a and head portion 122. As seen in FIG. 3, hinge 129 enables head portion 122 to tilt off-axis or to angle, upwardly or downwardly (as indicated by arrow “A”), with respect to a longitudinal axis of handle portion 124, 124a.

As seen in FIGS. 2-5, head portion 122 of cleaning attachment 120 includes at least one scouring element 142 operatively associated with a first or front surface 122a thereof for scrubbing the surfaces of the shower enclosure or bathtub. Desirably, cleaning attachment 120 includes a plurality of scouring elements 142. It is envisioned that scouring elements 142 may include, and are not limited to, sponges, bristles, and the like. If the scouring element 142 is a sponge, it is contemplated that the sponge may be a single larger sponge or a plurality of smaller sponges covering at least a portion of front surface 122a of head portion 122. If scouring element 142 consists of bristles, it is envisioned that the bristles may form a single bristled region covering at least a portion of front surface 122a, or a plurality of tufts of bristles, as shown in FIGS. 2-5, dispersed over at least a portion of front surface 122a of head portion 122.

While cleaning attachment 120 may be “non-powered” or “non-motorized”, as discussed above, it is envisioned and within the scope of the present disclosure for cleaning attachment 120 to be “powered” or “motorized” (i.e., include mechanisms and/or systems which deliver motion to scouring element 142).

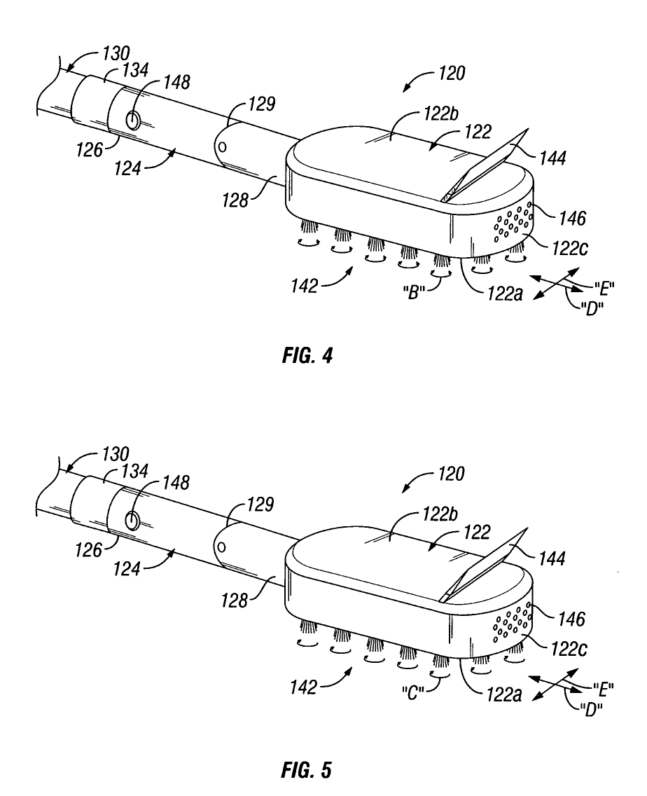

Desirably, head portion 122 of cleaning attachments 120 may be provided with a mechanism or system (not shown) which is capable of causing scouring elements 142 to rotatably oscillate, as indicated by arrow “B” in FIG. 4. Alternatively, head portion 122 of cleaning attachments 120 may be provided with a mechanism or system (not shown) which is capable of causing scouring elements 142 to rotate, as indicated by arrow “C” in FIG. 5. Optionally, head portion 122 of cleaning attachments 120 may be provided with a mechanism or system (not shown) which is capable of causing scouring elements 142 to oscillate in a longitudinal or transverse direction, as indicated by respective arrows “D and E” of FIGS. 4 and 5, with respect to a longitudinal axis of cleaning attachment 120.

Desirably, scouring elements 142 may be removed from head portion 122 of cleaning attachment 120 and replaced with new or sanitized scouring elements 142 as needed and/or desired.

It is envisioned that scouring elements 142 of cleaning attachment 120 may be driven or powered by, for example, fluid pressure, electrical energy, and the like. In an embodiment, as seen in FIG. 3, an electrical power pack or energy source 150 may be incorporated into handle 124a of cleaning attachment 120. Energy source 150 delivers power to the mechanism or system (not shown) used to drive scouring elements 142. Energy source 150 may include replaceable batteries, rechargeable batteries and the like.

As seen in FIGS. 2-5, head portion 122 of cleaning attachment 120 includes a squeegee 144 extending from a second or rear surface 122b thereof for wiping off excess water from the surfaces of the shower enclosure or bathtub.

Desirably, as seen in FIGS. 2-5, head portion 122 of cleaning attachment 120 includes at least one opening or aperture 146 formed in a distal surface 122c thereof. Desirably, during use, apertures 146 of head portion 122 permit water to exit therefrom in the form of a spray or the like. The water exiting apertures 146 of head portion 122 may be used to rinse of the surfaces of the shower enclosure of bathtub. While apertures 146 are shown and described as being provided in distal surface 122c of head portion 122, it is envisioned and within the scope of the present disclosure for apertures to be located anywhere around the surface of head portion 122, either an upper surface, a lower surface or a side surface.

It is envisioned and within the scope of the present disclosure for cleaning attachment 120 to be provided with a control switch 148 (i.e., an “on/off” switch”), see FIGS. 2-5, which is configured and adapted to open and close apertures 146 of head portion 122, or configured and adapted to permit water to be or prevent water from being delivered to apertures 146 of head portion 122.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A cleaning system for cleaning surfaces of a bath, shower enclosure, bath tub and the like, the cleaning system comprising:
a universal adapter configured and dimensioned for connection to a free end of a showerhead pipe of the bath;
a showerhead adapter configured and dimensioned for connection to a fitting of a shower head, wherein the universal adapter and the showerhead adapter are configured for selective fluid-tight connection with one another;
a tube having a first fitting provided at a first end thereof for fluid connection with the universal adapter, and a fitting provided at a second end thereof for fluid connection with a cleaning attachment; and
a cleaning attachment including:
a handle portion including a first end configured for fluid connection with the second fitting of the tube;
a head portion operatively supported on a second end of the handle portion; and
at least one scouring element operatively associated with the head portion of the cleaning attachment;
wherein the showerhead is replaced by the tube and cleaning attachment for cleaning the surfaces of the bath.

2. The cleaning system according to claim 1, wherein the universal adapter includes a quick release coupling for engaging each of the showerhead adapter and the first fitting of the tube.

3. The cleaning system according to claim 1, wherein the cleaning attachment includes a plurality of scouring elements extending from a first surface of the head portion.

4. The cleaning system according to claim 1, wherein the cleaning attachment includes a squeegee extending from a surface of the head portion which is opposite the scouring elements.

5. The cleaning system according to claim 1, wherein the head portion of the cleaning attachment is pivotable with respect to the handle portion.

6. The cleaning system according to claim 1, wherein the head portion of the cleaning attachment includes at least one aperture formed therein for discharge of fluid therefrom.

7. The cleaning system according to claim 6, wherein the cleaning attachment includes a control switch for opening and closing the apertures formed in the head portion thereof.

8. The cleaning system according to claim 1, wherein the scouring elements of the cleaning attachment are capable of oscillating in at least one a transverse direction and a longitudinal direction.

9. The cleaning system according to claim 1, wherein the scouring elements of the cleaning attachment are capable of rotating.

10. The cleaning system according to claim 1, wherein the cleaning attachment is configured and adapted to cause the scouring elements to at least one of rotate, oscillate in a transverse direction, and oscillate in a longitudinal direction.

11. The cleaning system according to claim 1, wherein the handle portion of the cleaning attachment is elongated.

12. The cleaning system according to claim 1, wherein the handle portion of the cleaning attachment has a length of from about 6 inches to about 24 inches.

13. The cleaning system according to claim 1, wherein the handle portion of the cleaning attachment has a length of from about 24 inches to about 60 inches.

14. A cleaning system for cleaning surfaces of a bath, shower enclosure, bath tub and the like, the cleaning system comprising:
a universal adapter configured and dimensioned for connection to a free end of a showerhead pipe of the bath;
a tube having a first fitting provided at a first end thereof for fluid connection with the universal adapter, and a fitting provided at a second end thereof for fluid connection with a cleaning attachment; and
a cleaning attachment attachable to the fitting at the second end of the tube, the cleaning attachment including:
a handle portion including a first end configured for fluid connection with the second fitting of the tube;
a head portion operatively supported on a second end of the handle portion; and
at least one scouring element operatively associated with the head portion of the cleaning attachment.

15. The cleaning system according to claim 14, wherein the universal adapter includes a quick release coupling for engaging the first fitting of the tube.

16. The cleaning system according to claim 15, wherein the cleaning attachment includes a plurality of scouring elements extending from a first surface of the head portion.

17. The cleaning system according to claim 16, wherein the cleaning attachment includes a squeegee extending from a surface of the head portion which is opposite the scouring elements.

18. The cleaning system according to claim 17, wherein the head portion of the cleaning attachment is pivotable with respect to the handle portion.

19. The cleaning system according to claim 18, wherein the head portion of the cleaning attachment includes at least one aperture formed therein for discharging fluid therefrom.

20. The cleaning system according to claim 19, wherein the cleaning attachment includes a control switch for opening and closing the apertures formed in the head portion thereof.

21. The cleaning system according to claim 20, wherein the cleaning attachment is configured and adapted to cause the scouring elements to at least one of rotate, oscillate in a transverse direction, and oscillate in a longitudinal direction.

22. The cleaning system according to claim 21, further comprising:
a showerhead adapter configured and dimensioned for connection to a fitting of a shower head, wherein the universal adapter and the showerhead adapter are configured for selective fluid-tight connection with one another, whereby the showerhead is replaced by the tube and cleaning attachment when cleaning the surfaces of the bath.
